(19) United States
(12) Patent Application Publication
(10) Pub. No.: US 2009/0027502 A1
(43) Pub. Date: Jan. 29, 2009

(54) Portable Apparatuses Having Devices for Tracking Object's Head, and Methods of Tracking Object's Head in Portable Apparatus

(75) Inventor: Yu-Kyung Yang, Gyeonggi-do (KR)

Correspondence Address: HARNESS, DICKEY & PIERCE, P.L.C., P.O. BOX 8910, RESTON, VA, 20195, US

(73) Assignee: KTF TECHNOLOGIES, INC.

(21) Appl. No.: 12/224,328

(22) PCT Filed: Feb. 23, 2007
(86) PCT No.: PCT/KR2007/000951

§ 371 Date: Aug. 25, 2008

(30) Foreign Application Priority Data
Feb. 24, 2006 (KR) 10-2006-0018034

(51) Int. Cl. H04N 7/18

(52) U.S. Cl. 348/169

(57) ABSTRACT

The portable apparatus includes camera section, head tracking section, image processor, video codec section and camera controller. The camera section obtains image of object. The head tracking section receives the image from the camera section, detects head area from the image, simulates the head area using model of ellipse, and calculates shape similarity, which represents similarity between the shape of the gradients of pixels at boundary of the ellipse and that of the ellipse, and color histogram similarity between internal area of candidate figure and internal area of the modeling figure. In order to obtain of the position of candidate ellipse of which color histogram similarity has maximum value, mean shift, which requires small amount of calculation with respect to first number of samples in internal area of the candidate ellipse, is used. Image processing section performs image-processing on the image based on quality information of the detected head area. Video codec section performs differential encoding on the detected head area based on the location of the detected head area. The camera controller controls rotation of the camera section on the basis of the location of the detected head area. Robust head tracking algorithm with small quantity of calculation is modified to be adapted to portable device, the user's head area may be tracked appropriately for the portable device.

### TECHNICAL FIELD

Example embodiments of the present invention relates to a portable apparatus, and more particularly to a portable apparatus having an apparatus for tracking object's head using a head tracking algorithm and methods of tracking object's head in the same.

### BACKGROUND ART

In image communication, information concerning an object's head area is more important than that of the object's the other area. A user should make an effort to maintain his head at the center of a screen when the image communication is performed or his head is recorded. However, in case that the user moves such as walking or riding a car, etc., it is difficult to maintain his head at the center of the screen.

A conventional portable device having a camera detects the user's head area from images outputted from the camera, and controls rotation of the camera in accordance with the detecting result so that the images outputted from the camera may continuously include the head area.

FIG. 1 is a block diagram illustrating a conventional portable device for controlling rotation of a camera in accordance with detection of user's head area.

Referring to FIG. 1, the portable device includes a camera 1, a video codec section 2, a wireless transmitter 3 and a camera rotation controller 4.

The video codec section 2 performs a motion estimation in a unit of a block on a video signal outputted from the camera 1 for the purpose of encoding operation, detects the location of the user's head using the motion estimation result, and provides the location of the user's head to the camera rotation controller 4. The camera rotation controller 4 controls the camera 1 based on the location of the user's head. The wireless transmitter 3 transmits a video image outputted from the video codec section 2 through an antenna. The video codec section 2 divides the image included in the video signal into a plurality of small blocks, and detects where the blocks corresponding to the user's head area is moved at next position of a screen. Then, the video codec section 2 designates an area corresponding to the moved blocks as a new user's head area.

A user's head area in the initial image should be known so as to apply the above technique. However, in case of real time application such as an image communication using a mobile communication terminal, it is difficult to provide an initial user's head area.

Additionally, since a method of estimating motion in a unit of block uses only similarity in the block, many errors are occurred in case that pixel(s) similar to the pixel(s) of the user's head area exists in a background. This is because the feature, by which the head area may be divided from the other area, of the head area is reduced when the image is divided into the small blocks.

For example, when a user's head exists in a flesh-colored background, location and size of the user's head are detected based on information such as eye, nose, lip, and hair, etc. However, in case that the image is divided into small blocks, it is difficult to distinguish blocks, which has only flesh-color, of a head from the flesh-colored background.

Further, common head tracking algorithms require much quantity of calculation, and so that the common head tracking algorithms are mainly employed in devices using a high-performance processor such as personal computer, etc. Accordingly, it is difficult to apply the common head tracking algorithms to a portable apparatus such as a mobile communication terminal.

### DISCLOSURE

### [Technical Problem]

It is a first object of the present invention to provide portable apparatuses having a head tracking device employing a robust head tracking algorithm with small quantity of calculation.

In addition, it is a second object of the present invention to provide methods of tracking an object's head in the portable apparatus employing a robust head tracking algorithm with small quantity of calculation.

### [Technical Solution]

A portable device according to an aspect of the present invention for the purpose of the first object of the present invention includes a camera section, a head tracking section and a camera controller. The camera section obtains an image of an object, the head tracking section detects an area, at which a first shape similarity and a color histogram similarity have maximum value, as a location of a head area, wherein the first shape similarity is a shape similarity between a candidate figure shown in the image of the object transmitted from the camera section and a modeling figure corresponding to a shape of a model head, and the color histogram similarity is a similarity between a first color histogram of an internal area of the candidate figure and a second color histogram of an internal area of the modeling figure. The camera controller controls a rotation of the camera section on the basis of the location of the detected head area. The portable apparatus may further include an image processing section configured to perform an image-processing on the image transmitted from the camera section on the basis of a quality information of the detected head area, and a video codec section configured to perform a differential encoding on the detected head area on the basis of the location of the detected head area. A number of samples in the internal area of the candidate figure may be a constant irrespective of a size of the candidate figure. The number of the samples may be determined on the basis of a frame rate of the image. The sample pixel may be densely selected in an internal area of a candidate figure having a first size, and may be sparsely selected in an internal area of a candidate figure having a second size larger than the first size. A number of samples at a boundary of the candidate figure shown in the image transmitted from the camera section may be a constant irrespective of the size of the candidate figure. The first shape similarity may be obtained by calculating a second shape similarity between first gradients of pixels existing at a boundary of the candidate figure and second gradients of pixels existing at a boundary of the modeling figure, and wherein magnitudes of vectors of the first and second gradients may be represented by binary codes so as to calculate the second shape similarity. The head tracking section may decide that a tracking is failed in case that a weight mean of the first shape similarity and the color histogram similarity is smaller than a given reference value, and may re-detect a location of the head area in accordance with the discrimination result. B−G, G−R and R+G+B color space may be used as a color space for calculating samples of the first and second color histograms, and a number of a color index of R+G+B may be smaller than that of a color index of B−G and G−R.

A portable device according to another aspect of the present invention for the purpose of the first object of the present invention includes a camera section, a head tracking section and a camera controller. The camera section obtain an image of an object. The head tracking section detects an area, at which a weight mean of a first shape similarity and a color histogram similarity have a maximum value, as a location of a head area, wherein the first shape similarity is a similarity between a candidate figure shown in the image transmitted from the camera section and a modeling figure corresponding to a shape of a model head, the color histogram similarity is a similarity between a first color histogram of an internal area of the candidate figure and a second color histogram of an internal area of the modeling figure, the first color histogram is obtained using a first number of samples in the internal area of the candidate figure, and the first number is a constant. The camera controller controls a rotation of the camera section on the basis of the location of the detected head area. A number of samples in the internal area of the candidate figure may be a constant irrespective of a size of the candidate figure. A number of samples at a boundary of the candidate figure shown in the image transmitted from the camera section may be a constant irrespective of the size of the candidate figure. The first shape similarity may be obtained by calculating a second shape similarity between first gradients of pixels existing at a boundary of the candidate figure and second gradients of pixels existing at a boundary of the modeling figure, and wherein magnitudes of vectors of the first and second gradients may be represented by binary codes so as to calculate the second shape similarity.

A method of tracking an object's face area in a portable device having a camera according to an aspect of the present invention for the purpose of the second object of the present invention includes obtaining a first candidate figure where a first color histogram similarity is more than or equal to a first reference value, the first color histogram similarity being a similarity between a model figure and N first samples in an internal area of candidate figures of a head image obtained by the camera, N being a natural number, calculating a first location of the head area at which a second color histogram similarity between the first candidate figure and the model figure has a maximum value, and detecting a second location of the head area and a size of the head area corresponding to the second location when a weight mean of a third color histogram similarity and a shape similarity has a maximum value, wherein the third color histogram similarity is a similarity between the model figure and M second samples in candidate figures generated by changing the size of the head area at the first location at which the second color histogram similarity has the maximum value, and the shape similarity is obtained based on to K third samples in a boundary of the candidate figures, M and K respectively is a natural number. The step of the obtaining the first candidate figure where a first color histogram similarity is more than or equal to a first reference value may include calculating the first color histogram similarity between the first samples and the model figure, accumulating a number of failed frames in case that the first color histogram similarity is smaller than a first reference value, and resetting an initial location of a second candidate figure with regard to a next frame of the head image obtained by the camera in case that the accumulated number of the accumulated failed frame is smaller than a given number, and then calculating the second color histogram similarity between the model figure and the first samples in an internal area of the second candidate figure. The method of tracking the head area may be stopped in case that the number of the accumulated failed frames are higher than the first reference value. The calculating a first location of the head area at which a second color histogram similarity between the first candidate figure and the model figure has a maximum value may include calculating the first location of the head area, at which a second color histogram similarity between the first candidate figure and the model figure has the maximum value, by applying a mean shift method. The step of the detecting a second location of the head area and a size of the head area corresponding to the second location when a weight mean of a third color histogram similarity and a shape similarity has a maximum value may include applying a mean shift method to each of candidate figures generated by changing the size of the head area at the first location at which the second color histogram similarity has the maximum value, thereby obtaining candidate figures converging to a convergence location, calculating the third color histogram similarity with respect to the second samples in an internal area of the converging candidate figures and a shape similarity of the third samples at a boundary of the converging candidate figures, and detecting the second location of the head area, at which the weight mean of the third color histogram similarity and the shape similarity has the maximum value, and the size of the head area corresponding to the second location. B−G, G−R and R+G+B color space may be used as a color space for calculating samples corresponding to the color histograms, and a number of color indexes of R+G+B may is smaller than that of color indexes of the B−G and the G−R. N may be a constant irrespective of a size of the candidate figures. M may be a constant irrespective of a size of the candidate figures. The method of tracking an object's face area in a portable device having a camera may further include controlling a rotation of the camera on the basis of the detected second location of the head area. The method of tracking an object's face area in a portable device having a camera may further include encoding differentially the detected head area on the basis of the detected second location of the head area.

### ADVANTAGEOUS EFFECTS

According to the portable apparatus having a head area tracking device, color histogram and shape information, which represent features of the whole head area, are used, and thus the portable device may detect more accurately a user's head area than the conventional motion estimation method in a unit of a block.

In addition, a robust head tracking algorithm with small quantity of calculation is modified to be adapted to a portable device, and is employed in the portable device. Therefore, the user's head area may be tracked appropriately for the portable device. The robust and rapid head tracking algorithm is used in the portable device, and thus image processing and differential video encoding for enhancing quality of the detected head area may be applied to the portable device, a head image having high quality may be continuously obtained through the control of camera rotation and the control of parameters, and so that the use efficiency of the portable device may be enhanced.

### DESCRIPTION OF DRAWINGS

Example embodiments of the present invention will become more apparent by describing in detail example embodiments of the present invention with reference to the accompanying drawings, in which:

FIG. 1 is a block diagram illustrating a common portable device for controlling rotation of a camera in accordance with detection of user's head area;

FIG. 2 is a block diagram illustrating a portable device employing a head tracking algorithm according to one example embodiment of the present invention;

FIG. 3 is a block diagram illustrating the head tracking section in FIG. 2;

FIG. 4 is a view illustrating a searching order of the user's area for detecting firstly the head area by employing the head tracking algorithm according to one example embodiment of the present invention; and

FIG. 5 is a flowchart illustrating a method of tracking the head in the head tracking section in FIG. 2.

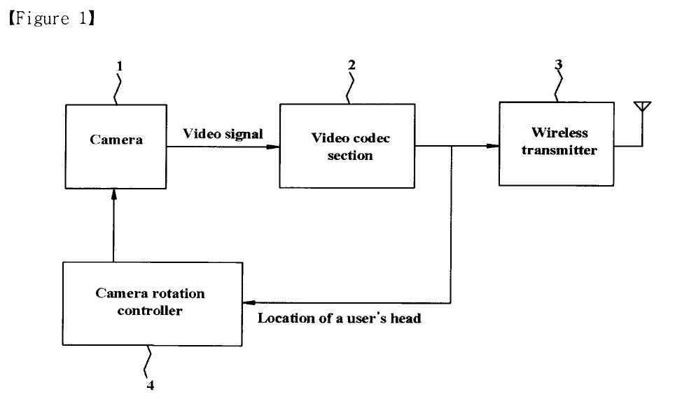

### MODE FOR INVENTION

Example embodiments of the present invention are disclosed herein. Hereinafter, the same reference numerals denote the same elements, and the detailed descriptions of the same elements will not be repeated.

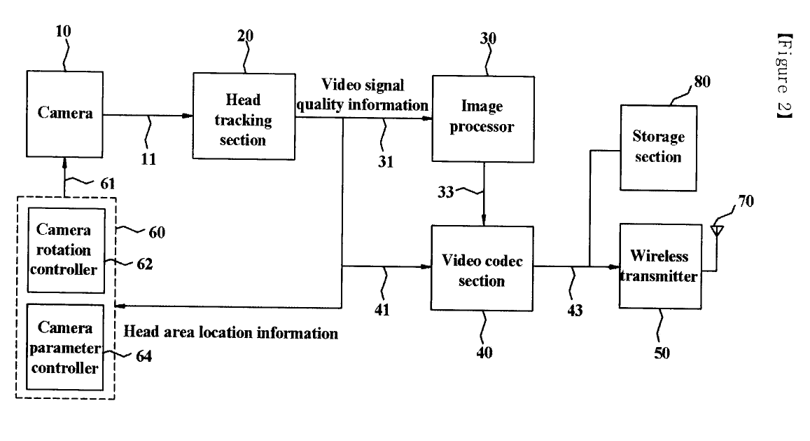

FIG. 2 is a block diagram illustrating a portable device employing a head tracking algorithm according to one example embodiment of the present invention.

Referring to FIG. 2, the portable device includes a camera 10, a head tracking section 20, an image processor 30, a video codec section 40, a wireless transmitter 50, a storage section 80 and a camera controller 60.

The portable device of the present embodiment locates the head tracking section 20 employing a head tracking algorithm before the video codec section 40, and detects a location and an area of a user's head based on color histogram, which distinguishes the whole head area from other area, and shape information.

The camera 10 has a rotating motor section (not shown) mounted therein to obtain an image.

The head tracking section 20 receives a video signal 11 from the camera 10, and detects a head area from the video signal 11 using a head tracking algorithm. In addition, the head tracking section 20 modifies partially Dorin Comaniciu's head tracking algorithm which employs a mean shift method having a robust detection ability with less calculation in accordance to characteristics of the portable device, and then uses the modified head tracking algorithm. In a common optimizing method, all function values are calculated directly and are compared each other so as to obtain a maximum point or a minimum point of a function. However, in the mean shift method, a next position is shifted repeatedly in the direction of high probability from a location of a present sample to converge to a location of a maximum value or a minimum value of a functionso as to calculate the maximum point or the minimum point of the function.

Additionally, in the Dorin Comaniciu's algorithm, the head area is simulated using a model, i.e. an area having an elliptical shape, and a candidate ellipse is selected so as to detect the head area. Here, the candidate ellipse is selected to satisfy the condition in which a color histogram of the pixels inside the candidate ellipse is the most similar to that of the model and a shape of gradients of pixels existing at a boundary of the candidate ellipse is the most similar to an ellipse. Further, the mean shift is employed for the purpose of obtaining the location at which a similarity of a histogram has the highest value.

The image processor 30 receives the video signal and image quality information 31 of the head area from the head tracking section 20, and performs an image processing prior to a video encoding of the video codec section 40 to obtain a better head image. Here, the image quality information includes luminance information, chroma information and contrast information, etc. For example, the image processor 30 analyzes the luminance information of the detected head area, and processes the head area brighter in case that it is analyzed that the head area is dark.

However, the image processor 30 omits above image processing in case that the received image has quality good enough not to need above image processing, or in case that a frame rate required by the video codec section 40 cannot be satisfied because the whole time required by the head tracking section 20 are all spent, and transmits directly the video signal to the video codec section 40.

The video codec section 40 receives location information 41 of the head area from the head tracking section 20, and performs a differential encoding so that the head area has higher quality than the other area. For example, the video codec section 40 may be MPEG2 (Moving Picture Experts Group 2) encoder or MPEG4 VM (Verification Model).

When the video codec section 40 employs the MPEG2, the video codec section 40 may quantizes DCT coefficients of blocks corresponding to the head area with a step size different from a step size that is used for quantizing DCT coefficients of blocks corresponding to the other area, thereby encoding the head area with high quality. Here, the location information of the head area at which a differential video encoding technique is employed is used for the quantization.

When the video codec section 40 employs the MPEG4 VM encoder, the video codec section 40 may divides objects, which is included in an image, into different VOPs (Video Object Planes) based on a motion picture encoding method, and encodes each of the VOPs. Here, the VOPs may be different in accordance with the objects. That is, the video codec section 40 provides the head area as one VOP, thereby encoding the head area with high quality.

Even though the camera 10 mounted to the portable device has a low resolution, the portable device may obtain the head image having high quality by using the image processing of the image processor 30 and the differential encoding of the video codec section 40.

An image 43 encoded by the video codec section 40 is stored in the storage section 80 of the portable device, or alternatively is transmitted through the wireless transmitter 50 in case of an image communication.

The camera controller 60 includes a camera rotation controller 62 and a camera parameter controller 64.

The camera rotation controller 62 receives the location information of the head area from the head tracking section 20, and determines rotation direction and rotation angle of the camera 10 so as to obtain next image. As a result, the user's head area is continuously located at a center of a screen.

The camera parameter controller 64 receives the image quality information from the head tracking section 20, and adjusts camera parameters, e.g. brightness, contrast, etc. so as to obtain the head image having better quality.

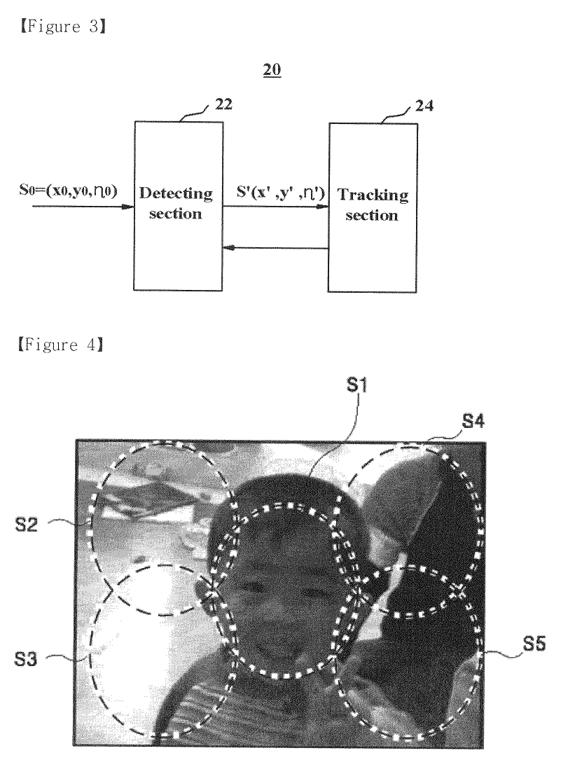

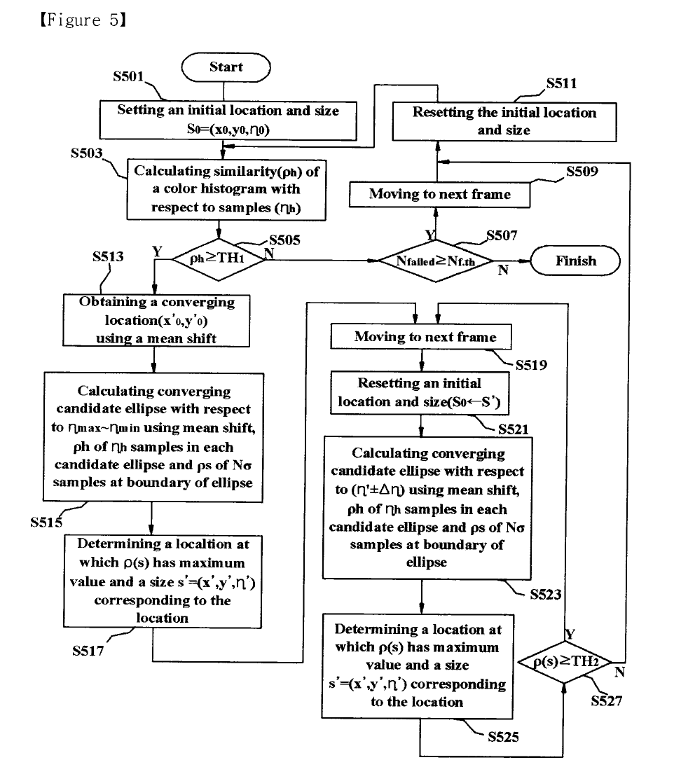

FIG. 3 is a block diagram illustrating the head tracking section in FIG. 2. FIG. 4 is a view illustrating a searching order of the user's area for the purpose of detecting initially the head area by employing the head tracking algorithm according to one example embodiment of the present invention. FIG. 5 is a flowchart illustrating a method of tracking the head in the head tracking section in FIG. 2.

Referring to FIG. 3, the head tracking section 20 includes a detecting section 22 and a tracking section 24.

The detecting section 22 detects an initial location and size of an initial head area from the image received from the camera 10.

The tracking section 24 tracks location and size of the next frame based on initial values, i.e. the initial location and size of the head area detected by the detecting section 22. That is, the location and size of the next frame is tracked by using the initial value, i.e. the location and size of the current frame. Here, a modeling shape of the head area may have, for example, an ellipse shape.

The tracking section 24 determines that the tracking is failed in case that a weight mean (referring to Expression 9) of a similarity of a color histogram in an internal area of an ellipse corresponding to the detected head area and a shape similarity at a boundary of the ellipse is smaller than a predetermined reference value. In this case, the detecting section 22 performs re-detecting process using the successfully tracked last location as an initial location of the re-detecting process.

Hereinafter, the method of tracking the head according to one example embodiment of the present invention will be described in detail with reference to FIG. 3 to FIG. 5. Here, the shape of a model head area and a candidate head area may be, for example, an ellipse.

Hereinafter, the model head area and the candidate head area are assumed to have an elliptical shape.

In step S501, the detecting section 22 included in the head tracking section 20 sets an initial input value S=(x₀,y₀,η₀) including a center location (x₀,y₀) of an initial candidate ellipse at which the detection is started and a minor axis length of the initial candidate ellipse. Here, the center location (S1 in FIG. 4) of the initial image provided from the camera 10 is set as the initial location (x₀,y₀) of the candidate ellipse because the head of a user probably exists near the center location of the screen due to the characteristics of an image communication.

The minor axis length η₀ of the candidate ellipse shows size of the ellipse, e.g. may be calculated from the size of a mean head image obtained from the images during the image communication. Here, the major axis length of the candidate ellipse may be proportional to the minor axis length, for example equals to about 1.2×η₀.

In step S503, the similarity of the color histogram ρₕ(s) with respect to a given number (nₕ) of samples in an internal area of the candidate ellipse is calculated by using a below Expression 1. Here, nₙ is a constant.

$${ρ}_{h} ( s ) = {\sum }_{u = 1}^{m} \sqrt{{p}_{u} ( s ) {q}_{u}} , \qquad < Expression 1 >$$

where qᵤ denotes a probability of u-th sample color index (or bin) in a model color histogram, and the model histogram may be calculated in advance from many head image samples. In addition, S indicates a vector S=(x₀,y₀,η₀) representing the center location (x₀,y₀) and the minor axis length η₀ of the candidate ellipse, and pᵤ(s) denotes a probability of u-th sample color index (or bin) in the color histogram of the internal area of the candidate ellipse. Moreover, m indicates the number of the color indexes (or bin).

Increase of the similarity of the color histogram in Expression 1 means that more than a certain rate of the user's head area is included in the area of the candidate ellipse (candidate ellipse area).

In the user's head area included in the candidate ellipse area, the probability of the u-th sample color index in the model color histogram is similar to that of the u-th sample color index (or bin) in the color histogram in the internal area of the candidate ellipse, thereby increasing the similarity of the color histogram in Expression 1. Whereas, in the user's head area which is not included in the candidate ellipse area, the probability of the u-th sample color index in the model color histogram is not similar to that of the u-th sample color index (or bin) in the color histogram in the internal area of the candidate ellipse, thereby decreasing the similarity of the color histogram.

In one example embodiment of the present invention, B−G, G−R, R+G+B color spaces having a robust tracking ability instead of R−G color space normalized with brightness are used as a color space for obtaining a histogram sample. Here, the B−G, G−R, R+G+B color spaces may use 32-bin color histogram, 32-bin color histogram and 4-bin color histogram, respectively. The B−G and the G−R respectively represents the difference between B and G, R and G, wherein G has much luminance information, and thus the B−G and the G−R have much chrominance information. The R+G+B has much luminance information.

In one example embodiment of the present invention, the number of the color indexes (or bins) of the R+G+B is set to be relatively small, and so that the portable device may have a robust detecting ability against the variation of luminance because the variation of luminance leads to much variation of a real image. In addition, the portable device may track the head area having a hair as well as a face area to have the robust ability of separating distinctly the head area from a background area.

FIG. 2 and FIG. 3 represent the model histogram and the histogram in the internal area of the candidate ellipse (or candidate histogram), respectively.

$$\begin{matrix}{\hat{q}}_{u} ( s ) = C {\sum }_{i = 1}^{n} k ( {‖ {x}_{i}^{*} ‖}^{2} ) δ [ b ( {x}_{i}^{*} ) - u ) ] & < Expression 2 > \\ {\hat{p}}_{u} ( s ) = {C}_{h} {\sum }_{i = 1}^{n} k ( {‖ \frac{y - {x}_{i}}{h} ‖}^{2} ) δ [ b ( {x}_{i} ) - u ) ] & < Expression 3 >\end{matrix}$$

{xᵢ*}i=1 . . . n denotes a location of a normalized pixel from a center location when a model image area is normalized as a unit circle having a radius of 1, and b(xᵢ*) denotes an index of histogram (or bin) corresponding to color of location xᵢ*. Additionally, y denotes a vector y=(x₀,y₀) representing the center location of the candidate ellipse, and xᵢ denotes location of each of pixels in the internal area of the candidate ellipse of which center location is the vector y. Moreover, h is related to the size of the candidate ellipse, and denotes a normalization factor that is used for normalizing location (y−xᵢ) of each pixel as a location of a unit circle having a radius of 1, wherein (y−xᵢ) denotes a location of each pixel from he center location of the candidate ellipse. h denotes a variable in proportion to the size η₀ of the candidate ellipse.

Further, k(sᵢ) is a Kernel function distributed in a unit circle, and provides a weight that varies depending on the distance from the center location.

Each of C and Cₕ respectively is a normalization function, and is expressed as a below Expression 4.

$$C = \frac{1}{{\sum }_{i = 1}^{n} k ( {‖ {x}_{i}^{*} ‖}^{2} )} , {C}_{h} = \frac{1}{{\sum }_{i = 1}^{n} k ( {‖ \frac{y - {x}_{i}}{h} ‖}^{2} )} \qquad < Expression 4 >$$

In step S505, the detecting section 22 calculates the similarity ρₕ(s) of the color histogram with respect to the initial location and initial size, and then compares the similarity ρₕ(s) with a given reference value TH1. Here, in case that more than certain rate of the user's head area is included in the candidate ellipse area, ρₕ(s) has a value higher than the given reference value TH1. Accordingly, the detecting section 22 may judge that the user's head area exists near the candidate ellipse.

In step S507, in case that ρₕ(s) has a value below TH1, the number Nfailed, which denotes the number of accumulated fail frames, is compared with a given reference number Nf.th.

In step S509, in case that the number Nfailed is smaller than the reference number Nf.th, the process of tracking head area is moved to the next frame. Then, in step S511, the initial location is reset to a location—e.g. one of S2, S3, S4 and S5 in FIG. 4—different from the location in the step S501. Subsequently, the similarity ρₕ(s) of the color histogram in the step S503 is calculated.

In the next frame, the location—e.g. one of S2, S3, S4 and S5 in FIG. 4—remotely spaced from S1 is searched as an initial location instead of a location next to S1. The user's head area does not vary much in two continuous frames. Therefore, the probability that the user's head area is detected near S1 at the next frame is low when the user's head area is not detected near S1 at the current frame.

In case that the number Nfailed is higher than the reference number Nf.th, an operation of detecting the head area is finished, and then the image is transmitted to the video codec section 40.

The above process is repeatedly performed until a candidate ellipse having the similarity of the color histogram more than the reference number TH1 is found.

For example, when the reference number Nf.th is 5, in case that the similarity of the color histogram calculated at the initial location S1 in a-th frame is smaller than TH1, the accumulated number Nfailed of the failed frame is 1. In case that the similarity of the color histogram calculated at the location S2 in (a+1)-th frame is smaller than TH1, the accumulated number Nfailed is 2. In case that the similarity of the color histogram calculated at the location S3 in (a+2)-th frame is smaller than TH1, the accumulated number Nfailed is 4. In case that the similarity of the color histogram calculated at the location S4 in (a+3)-th frame is smaller than TH1, the accumulated number Nfailed is 5. In case that the similarity of the color histogram calculated at the location S5 in (a+4)-th frame is smaller than TH1, the accumulated number Nfailed is 6. In this case, since the accumulated number Nfailed is higher than the reference number Nf.th, the process of detecting the head area is finished.

In case that the similarity of the color histogram calculated in the step S503 is more than TH1 while the accumulated number Nfailed is smaller than the reference number Nf.th, the steps below S515 are performed so as to calculate more accurately the location and size of the head area.

In step S513, in case that a candidate ellipse, which is one of the candidate ellipses (S1, S2, S3, S4 and S5 in FIG. 4) having the same size, having the similarity ρₕ(s) more than TH1 is found at a location (x₀,y₀)a new location (x′₀,y′₀) at which the similarity ρₕ(s) has a maximum value is obtained by using the mean shift method.

In order to apply the mean shift way, a taylor expansion is performed on ρₕ(s) near to \hat{P}ᵤ(ŷ₀) and then Expression 3 is inserted into Expression 1, ρₕ(s) may be represented as a Kernel density prediction function shown in Expression 5. Here, ŷ₀ indicates a center location of the current candidate ellipse. The length of the minor axis of the candidate ellipse is constant during the mean shift method. That is, h is constant.

$${ρ}_{h} ( S ) = {C}_{h} {\sum }_{u = 1}^{m} {ω}_{i} k ( {‖ \frac{y - {x}_{i}}{h} ‖}^{2} ) , \\ {ω}_{i} = {\sum }_{u = 1}^{m} \sqrt{\frac{{\hat{q}}_{u}}{{\hat{p}}_{u} ( {\hat{y}}_{0} )}} δ [ b ( {x}_{i} ) - u ) ] \qquad < Expression 5 >$$

In the mean shift's theory, a new location ŷ₁ that approaches toward a maximum point of ρₕ(s) is calculated as shown in Expression 6 when ρₕ(s) has the kernel density prediction function that has smoothly monotone increasing characteristics. Subsequently, another new location ŷ₁ is repeatedly calculated by using the calculated new ŷ₁ as the initial location ŷ₀. Then, a converging location ŷ₁ may be calculated, and so that a location at which ρₕ(s) has a maximum value may be calculated.

$${\hat{y}}_{1} = \frac{{\sum }_{i = 1}^{{n}_{h}} {x}_{i} {ω}_{i} g ( {‖ \frac{{\hat{y}}_{o} - {x}_{i}}{h} ‖}^{2} )}{{\sum }_{i = 1}^{{n}_{h}} {ω}_{i} g ( {‖ \frac{{\hat{y}}_{o} - {x}_{i}}{h} ‖}^{2} )} , g ( x ) i ) = {k}^{′} ( {x}_{i} ) \qquad < Expression 6 >$$

k(xᵢ) may be an Expanechinikov kernel that has monotone decreasing

characteristics and a convex center so as to reduce the amount of calculation.

Since g(xᵢ), which is obtained by differentiating k(xᵢ), is a uniform kernel, g(xᵢ) is eliminated. As a result, ŷ₁ is derived as shown in Expression 7.

$${\hat{y}}_{1} = \frac{{\sum }_{i = 1}^{{n}_{h}} {x}_{i} {ω}_{i}}{{\sum }_{i = 1}^{{n}_{h}} {ω}_{i}} , \\ {ω}_{i} = {\sum }_{u = 1}^{m} \sqrt{\frac{{\hat{q}}_{u}}{{\hat{p}}_{u} ( {\hat{y}}_{0} )}} δ [ b ( {x}_{i} ) - u ) ] \qquad < Expression 7 >$$

ωᵢ denotes a similarity between a probability of a histogram (or bin) corresponding to the color of a sample location xᵢ in an internal area of each candidate ellipse and a probability of a bin corresponding to the model color histogram. Expression 7 shows that a weight mean ŷ₁ corresponds to a new location which approaches toward the maximum point of ρₕ(s), wherein ŷ₁ is a weight mean obtained by using ωᵢ as a weight factor. A new location ŷ₁ is repeatedly calculated, and converging ŷ₁ is obtained, thereby obtaining a location corresponding to a maximum value of ρₕ(s).

Above method is not a whole detecting method of detecting a location at which ρₕ(s) has a maximum value by calculating ρₕ(s) at every candidate location, and thus the calculated maximum value may be a local maximum point. However, since ρₕ(s) has a distribution having one maximum point in the image that mainly includes the head area, for example, the image of an image communication, a probability that the maximum point corresponds to the local maximum point is low.

Further, the maximum point of ρₕ(s) may be easily calculated by repeating the above calculating process by several times so that above method may be appropriate for a real time application. Here, ηₕ is the number of sample pixels in the internal area of the candidate ellipse, and is proportional to the amount of calculation.

The portable device according to example embodiments of the present invention modifies partially the head tracking algorithm that uses the mean shift method so that the modified head tracking algorithm may be adapted to characteristics of the portable device. In particular, the portable device according to example embodiments of the present invention uses ηₕ that is a given constant, and thus the amount of calculation is not increased although the size of the candidate ellipse is increased. That is, a sample pixel is densely selected in an internal area of the candidate ellipse having a first size, and is sparsely selected in an internal area of the candidate ellipse having a second size larger than the first size.

In case that ηₕ is very small, the detection result may be not satisfactory. Whereas, ηₕ having very large constant may not be accommodated to the frame rate required by the video codec section 40. Accordingly, ηₕ is determined with reference to above situation.

Further, since the number of repeating above calculating process is proportional to the detecting time, the portable device stops the calculating the converging location at the current location in case that the location is not converging within a specific time, and then transmits the image to the video codec section 40 so as to satisfy a time required by the video codec section 40.

In the next frame, the portable device performs again the mean shift using the location at which calculating the convergence is stopped as the initial location.

In step S513, a convergence location (x′₀,y′₀) at which the similarity ρₕ(s) of the color histogram has a maximum value is calculated by using the mean shift way. At the convergence location (x′₀,y′₀) a center of an candidate ellipse which converges into the location (x′₀,y′₀) is near to a center of the user's head.

Referring back to FIG. 5, in the step S515, accurate size and accurate location are calculated, and the mean shift is applied to each of the candidate ellipses of which sizes η are decreased from ηₘₐₓ to ηₘᵢₙ by a given decreasement, thereby calculating respective convergence location corresponding to the respective candidate ellipse. Accordingly, candidate ellipses converging to the convergence locations are obtained. For example, the portable device applies the mean shift to each of three candidate ellipses having different sizes at the convergence location (x′₀,y′₀) in the step S513, thereby calculating three convergence locations corresponding to the three candidate ellipses, respectively. Accordingly, the three candidate ellipses converging to the three convergence locations are obtained.

The similarity of the color histogram ρₕ(s) (Expression 1) with respect to nₕ samples in the internal area of the converging candidate ellipses and the shape similarity ρₛ(s) (Expression 8) with respect to t samples at the boundary of the candidate ellipses are calculated. Here, the shape similarity may be obtained by applying a modified Dorin Comaniciu's method.

The Dorin Comaniciu calculates gradients of pixels existing at the boundary of the candidate ellipse, and applies a Stan Birchfield method of measuring how much the gradients is close to to an ellipse shape in accordance with the calculated result.

Then, the shape similarity is calculated by using a below Expression 8.

$${ρ}_{s} ( S ) = \frac{1}{{N}_{σ}} {\sum }_{i = 1}^{{N}_{σ}} \vert {n}_{σ} ( i ) \cdot {g}_{i} ( i ) \vert \qquad < Expression 8 >$$

S indicates a vector s(η₀) representing the center location (x₀,y₀) and the size η₀ of the candidate ellipse, and N_{σ} denotes the number of samples at the boundary of the candidate ellipse. In addition, n_{σ}(i) indicates a unit normal vector of I-th sample at the boundary of the candidate ellipse, and gᵢ(i) denotes an intensity gradient vector of a pixel corresponding to the I-th sample at the boundary of the candidate ellipse.

The portable device of the example embodiments of the present invention modifies the head tracking algorithm of the Dorin Comaniciu, and then uses the modified head tracking algorithm.

In other words, a conventional algorithm uses gᵢ(i) as it is without modification. However, according to example embodiments of the present invention, magnitudes of gᵢ(i) vector are represented by binary-codes so that the direction of the gradient has a higher weight than the magnitude of the gradient, thereby detecting how much the gradient of pixels existing at the boundary of the candidate ellipse is similar to the gradient corresponding to an ellipse. This is because a great gradient does not always exist at the boundary of the user's head.

In case of using the magnitude of the gradient as it is without modification, an undesired candidate ellipse may be selected when a great gradient exists in the background of the head or in the internal area of the head.

In case that the magnitude of the gradient is larger than or equal to a given reference value, the magnitude of the gradient is binary-coded to have a binary number ‘1’. However, in case that the magnitude of the gradient is less than the given reference value, the magnitude of the gradient is binary-coded to have a binary number ‘0’.

Additionally, since the number of the samples at the boundary of the candidate ellipse is proportional to the amount of calculation, the number of the samples is set to have a constant based on the detection result and the frame rate required by the video codec section 40.

Now referring back to FIG. 5, a location, at which the weight mean ρ(s) expressed in Expression 9 has the maximum value, and a size s′=(x′,y′,η′) corresponding to the location are determined in step S517. As a result, the detection of the location and size of the head area by the detecting section 22 is finished. Here, the weight mean ρ(s) equals to a sum of a first product of the similarity ρₕ(s) of the color histogram and a first weight and a second product of the shape similarity ρₛ(s) and a second weight.

### <Expression 9>

ρ(s)=αρₕ(s)+(1−α)ρₛ(s), where α is a real number between 0 and 1.

In step S519, the tracking section 24 moves to the next frame so as to track the location and the size of the next frame after the detecting section 22 detects the location and the size of the head area of the current frame.

In step S521, the tracking section 24 sets the location and the size s′=(x′,y′,η′) detected by the detecting section 22 as an initial value S₀.

In step S523, the portable device detects the candidate ellipses converging to a given location by applying the mean shift (Expression 7) with respect to three candidates (η′,η′±Δη,η′−Δη)having magnitudes of η′,η′±Δη and then calculates the similarity ρₕ(s) of the color histogram of tηₕ samples in internal areas each of the converged candidate ellipses and the shape similarity ρₛ(s) of N_{σ} samples at the boundary of the candidate ellipse.

In step S525, the portable device calculates the weight mean ρ(s) (Expression 9) with respect to the converging three candidate ellipses, and determines a location and a size s′=(x′,y′,η′) of a candidate ellipse having the maximum value of the weight mean ρ(s) in accordance with the calculating result.

In step S527, the tracking section 24 determines whether or not the weight mean is less than a given reference value TH2. In case that the weight mean is less than TH2, the tracking section 24 determines that the tracking is failed, and then performs the re-detecting process in step S511. In this case, the location and the size of the last head area tracked successfully are set as an initial location and a size in step S511.

In case that the weight mean is larger than or equal to TH2, the step S519 is again performed. Then, the process of tracking the head area is applied to the next frame and is repeated. Here, in the steps S503, S515 and S523, the number of samples in an internal area of one of the candidate ellipses is identical to that of samples in an internal area of another candidate ellipse, or alternatively the number of samples in internal areas of the candidate ellipses may be different from one another.

Example embodiments of the present invention may be employed in a mobile communication device for image communication. In addition, the example embodiments of the present invention are not limited to field of the image communication, and may be employed in the fields such as a video conference, a remote education, etc.

### INDUSTRIAL APPLICABILITY

According to the portable apparatus having a head area tracking device, color histogram and shape information, which represent features of the whole head area, are used, and thus the portable device may detect more accurately a user's head area than the conventional motion estimation method in a unit of a block.

In addition, a robust head tracking algorithm with small quantity of calculation is modified to be adapted to a portable device, and is employed in the portable device. Therefore, the user's head area may be tracked appropriately for the portable device.

The robust and rapid head tracking algorithm is used in the portable device, and thus image processing and differential video encoding for enhancing quality of the detected head area may be applied to the portable device, a head image having high quality may be continuously obtained through the control of camera rotation and the control of parameters, and so that the use efficiency of the portable device may be enhanced.

Although embodiments have been described with reference to a number of illustrative embodiments thereof, it should be understood that numerous other modifications and embodiments can be devised by those skilled in the art that will fall within the spirit and scope of the principles of this disclosure.

1. A portable apparatus comprising:
a camera section configured to obtain an image of an object;
a head tracking section configured to detect an area, at which a first shape similarity and a color histogram similarity have maximum value, as a location of a head area, wherein the first shape similarity is a shape similarity between a candidate figure shown in the image of the object transmitted from the camera section and a modeling figure corresponding to a shape of a model head, and the color histogram similarity is a similarity between a first color histogram of an internal area of the candidate figure and a second color histogram of an internal area of the modeling figure; and
a camera controller configured to control a rotation of the camera section on the basis of the location of the detected head area.

2. The portable apparatus of claim 1, wherein a number of samples in
the internal area of the candidate figure is a constant irrespective of a size of the candidate figure.

3. The portable apparatus of claim 2, wherein the number of the samples is determined on the basis of a frame rate of the image.

4. The portable apparatus of claim 1, wherein a sample pixel is densely
selected in an internal area of a candidate figure having a first size, and is sparsely selected in an internal area of a candidate figure having a second size larger than the first size.

5. The portable apparatus of claim 1, wherein a number of samples at a boundary of the candidate figure shown in the image transmitted from the camera section is a constant irrespective of the size of the candidate figure.

6. The portable apparatus of claim 1, further comprising:
an image processing section configured to perform an image-processing on the image transmitted from the camera section on the basis of a quality information of the detected head area; and
a video codec section configured to perform a differential encoding on the detected head area on the basis of the location of the detected head area.

7. The portable apparatus of claim 1, wherein the first shape similarity
is obtained by calculating a second shape similarity between first gradients of pixels existing at a boundary of the candidate figure and second gradients of pixels existing at a boundary of the modeling figure, and
wherein magnitudes of vectors of the first and second gradients are
represented by binary codes so as to calculate the second shape similarity.

8. The portable apparatus of claim 1, wherein the head tracking section decides that a tracking is failed in case that a weight mean of the first shape similarity and the color histogram similarity is smaller than a given reference value, and re-detects a location of the head area in accordance with the discrimination result.

9. The portable apparatus of claim 1, wherein B−G, G−R and R+G+B color space are used as a color space for calculating samples of the first and second color histograms, and a number of a color index of R+G+B is smaller than that of a color index of B−G and G−R.

10. A portable apparatus comprising:
a camera section configured to obtain an image of an object;
a head tracking section configured to detect an area, at which a weight mean of a first shape similarity and a color histogram similarity have a maximum value, as a location of a head area, wherein the first shape similarity is a similarity between a candidate figure shown in the image transmitted from the camera section and a modeling figure corresponding to a shape of a model head, the color histogram similarity is a similarity between a first color histogram of an internal area of the candidate figure and a second color histogram of an internal area of the modeling figure, the first color histogram is obtained using a first number of samples in the internal area of the candidate figure, and the first number is a constant; and
a camera controller configured to control a rotation of the camera section on the basis of the location of the detected head area.

11. The portable apparatus of claim 10, wherein a number of samples in the internal area of the candidate figure is a constant irrespective of a size of the candidate figure.

12. The portable apparatus of claim 10, wherein a number of samples at a
boundary of the candidate figure shown in the image transmitted from the camera section is a constant irrespective of the size of the candidate figure.

13. The portable apparatus of claim 10, wherein the first shape similarity is obtained by calculating a second shape similarity between first gradients of pixels existing at a boundary of the candidate figure and second gradients of pixels existing at a boundary of the modeling figure, and
wherein magnitudes of vectors of the first and second gradients are represented by binary codes so as to calculate the second shape similarity.

14. A method of tracking a head area of an object' in a portable apparatus
having a camera, the method comprising:
obtaining a first candidate figure where a first color histogram similarity is more than or equal to a first reference value, the first color histogram similarity being a similarity between a model figure and N first samples in an internal area of candidate figures of a head image obtained by the camera, N being a natural number;
calculating a first location of the head area at which a second color histogram similarity between the first candidate figure and the model figure has a maximum value; and
detecting a second location of the head area and a size of the head area corresponding to the second location when a weight mean of a third color histogram similarity and a shape similarity has a maximum value,
wherein the third color histogram similarity is a similarity between the model figure and M second samples in candidate figures generated by changing the size of the head area at the first location at which the second color histogram similarity has the maximum value, and the shape similarity is obtained based on to K third samples in a boundary of the candidate figures, M and K respectively is a natural number.

15. The method of claim 14, wherein the step of the obtaining the first candidate figure where a first color histogram similarity is more than or equal to a first reference value includes:
calculating the first color histogram similarity between the first samples and the model figure;
accumulating a number of failed frames in case that the first color histogram similarity is smaller than a first reference value; and
resetting an initial location of a second candidate figure with regard to a next frame of the head image obtained by the camera in case that the accumulated number of the accumulated failed frame is smaller than a given number, and then calculating the second color histogram similarity between the model figure and the first samples in an internal area of the second candidate figure.

16. The method of claim 15, wherein the method of tracking the head area is stopped in case that the number of the accumulated failed frames are higher than the first reference value.

17. The method of claim 14, wherein the calculating a first location of the head area at which a second color histogram similarity between the first candidate figure and the model figure has a maximum value includes calculating the first location of the head area, at which a second color histogram similarity between the first candidate figure and the model figure has the maximum value, by applying a mean shift method.

18. The method of claim 14, wherein the step of the detecting a second location of the head area and a size of the head area corresponding to the second location when a weight mean of a third color histogram similarity and a shape similarity has a maximum value includes:
applying a mean shift method to each of candidate figures generated by changing the size of the head area at the first location at which the second color histogram similarity has the maximum value, thereby obtaining candidate figures converging to a convergence location;
calculating the third color histogram similarity with respect to the second samples in an internal area of the converging candidate figures and a shape similarity of the third samples at a boundary of the converging candidate figures; and
detecting the second location of the head area, at which the weight mean of the third color histogram similarity and the shape similarity has the maximum value, and the size of the head area corresponding to the second location.

19. The method of claim 14, wherein B−G, G−R and R+G+B color space are used as a color space for calculating samples corresponding to the color histograms, and a number of color indexes of R+G+B is smaller than that of color indexes of the B−G and the G−R.

20. The method of claim 14, wherein N is a constant irrespective of a size of the candidate figures.

21. The method of claim 14, wherein M is a constant irrespective of a
size of the candidate figures.

22. The method of claim 14, further comprising:
controlling a rotation of the camera on the basis of the detected second location of the head area.

23. The method of claim 14, further comprising:
encoding differentially the detected head area on the basis of the detected second location of the head area.
